(19) United States
(12) Patent Application Publication
(10) Pub. No.: US 2003/0129285 A1
(43) Pub. Date: Jul. 10, 2003

(54) Method and device for stuffing food items

(76) Inventor: Gerald T. Mattson, Fitzwilliam, NH (US)

Correspondence Address: Gerald T Mattson, 94 Richmond Rd, PO Box 74, Fitzwilliam, NH, 03447, US

(21) Appl. No.: 10/037,162

(22) Filed: Jan. 4, 2002

(51) Int. Cl. A23G 1/00

(52) U.S. Cl. 426/132

(57) ABSTRACT

Device and method to selectively place desired stuffing into food items such as tenderloin, fish fillet, chicken breast or other food items, which are deemed stuffable. A kit of parts, consisting of at least but not limited to two substantially flat rollable sheets that are of the desired lengths, widths and thickness, a number of push rods of desired lengths and diameters. A method that utilizes said components in an efficient process that allows a chef to enhance a foods flavor, appearance and nutritional value.

### BACKGROUND

1. Field of the Invention

This invention and method relates to preparation of foods for home use or in a restaurant, specifically food items which the person preparing the food, would want to place stuffing into.

2. Related Art

Hereunto, chefs in a restaurant or at home had no choice as to the method of stuffing food items. Normally tenderloin, fillet of fish, fowl breast or other stuffable food had to be sliced. The chef would then lay it open in a butterfly fashion, or open the pocket formed, spoon on the appropriate quantity of stuffing. The chef would now fold the two pieces together and sew, tie with string or use wooden, metal rods to hold the stuffed item closed. There has not until the present invention been a device or method that empowers a chef to deposit stuffing into a food item to any desired depth through an aperture of minimal size

Having searched in (1) United States Patent and Trademark Office (USPTO), (2) the IBM patent database and (3) ran numerous Boolean queries and visited various web sites, such as Lehman's and Chefs without locating any accessories for food preparation of this type and versatility.

### References Cited (Referenced By)

| | | | |
|---|---|---|---|
| U.S. Pat. No. 6,117,467 | September 2000 | Huling | 426/281 |
| U.S. Pat. No. 3,890,675 | June 1975 | Nausedas | 17/41 |
| U.S. Pat. No. 4,438,145 | March 1984 | Bakker | 426/279 |
| U.S. Pat. No. 4,669,967 | June 1987 | Hayashi | 425/376 |
| U.S. Pat. No. 5,900,265 | May 1999 | Rutherford | 426/281 |

In reviewing previous art, the most relevant patent, U.S. Pat. No. 6,117,467 reveals a elongated hollow sleeve with a generally square cross section and longitudinal bore. One end is cut at an angle the other has an enlarged head. A window is cut through the wall in the middle. There is also an elongated plunger, which is round in cross section. This is not an efficient design, as any viscous stuffing will travel up the inside corners around the plunger. The apparatus is stainless steel and is utilized by plunging it into a piece of meat to the desired depth and withdrawing the plunger to expose the window. At this point the stuffing can be loaded into the square tube and the plunger pushed forward to inject the stuffing into the item being stuffed. Having a square bore would present a problem with maintaining cleanliness. U.S. Pat. No. 3,890,675 discloses a stuffing horn with a product stoppering and severing device that moves into and out of the tapered end of the horn. This device is intended to be used to stuff sausage and is only capable of utilizing a viscous pumpable mass, which is then pumped mechanically into a flexible casing. U.S. Pat. No. 4,438,145 describes a process for stuffing a meat bird in which a wrap of edible material is folded around the stuffing. The wrap, which is put around the stuffing mechanically, has been adapted for such products as egg rolls, burritos, tortillas and cannelloni. Of considerably less relevance is U.S. Pat. No. 4,669,967, reveals a nozzle, piston and cylinder mechanism for taking in food and extruding it in specific shape and amount so as to have all items identical, such as frankfurters, sausage and the like. U.S. Pat. No. 5,900,265 unveils an apparatus for filling substantially round food (mainly pastries and other baked goods) by means of a coiled tube. The tube is inserted into a food item that is rotationally restrained while said tube is turned into the pastry. Filling then pumped into said food in a predetermined quantity.

My present invention describes a device and method that is very user friendly, easy to keep clean and is extremely versatile unlike the above mentioned Prior Art, heretofore known suffer from a number of disadvantages.

(a) The previous art patents are very complicated and would require well-trained personnel to operate safely and efficiently.

(b) There would be difficulty in maintaining them as the mechanical components will wear, and metal components would be prone to corrosion and other effects of the environment involved.

(c) All except U.S. Pat. No. 6,117,467 can only utilize viscous pumpable products and are not suited for use in the home or a restaurant.

(d) The prior art mentioned is very limited as to what types of items that can be stuffed.

(e) The prior art does not allow for the desired stuffing to be stratified.

(f) The afore mentioned art is much more difficult to maintain in a clean and sanitary condition.

(g) The previous art except U.S. Pat. No. 6,117,467 are stationary and are not suited for the home or restaurant.

### SUMMARY OF THE PRESENT INVENTION

Particularly the invention is a Kit of Parts, rollable and unrollable substantially flat sheets (of various sizes of about 6″×11″×0.007″ thick) and push rods (of selected lengths and diameters) that are snugably and slidebly insertable into the rolled flat sheet. More particularly the method for stuffing food such as pork tenderloin, fish fillet, fowl breast or any other stuffable food items with edible stuffing. The stuffing may be viscous, solid or any combination that the chef may decide is appropriate for the food item to be stuffed Other considerations such as nutritional value, appearance and taste combinations are all addressed by my invention.

### OBJECTS AND ADVANTAGES

Accordingly, besides the objects and advantages of the Kit of Parts described in my above patent, several objects and advantages of the present invention are but not limited to the following.

(a) to provide a device for stuffing food items which is very easy to keep clean and sanitary.

(b) to provide a device that when not in use is compact and stores very easily.

(c) to provide a device that permits the chef to stratify or arrange components that are contained in the stuffing, in an order specified by the chef.

(d) to provide a device which allows the chef to stuff a variety of items in a uniform manner.

(e) to provide a device that will deposit stuffing of any consistency into a desired item.

(f) to provide a device which makes stuffing a food item very efficient.

(g) to provide a device which enables a chef in the home or restaurant to create very tasteful, nutritious, and visually appealing foodstuffs for consumption.

(h) to provide a method of inserting a desired stuffing into any food item that an aperture and thus a cavity may be created.

(i) to provide a method of organizing or stratifying the stuffing.

(j) to provide a method for rapidly stuffing several items in a uniform manner.

(k) to provide a method of depositing stuffing of any consistency into a desired food item.

(l) to provide a method for the deposition of stuffing in a food item that is efficient.

(m) to provide a method of depositing stuffing which is easily used in the home or restaurant.

Further objects and advantages are to provide home and restaurant chefs with a device and a method that is convenient, easily used and will allow a chef to combine any number of ingredients desired which will result in a taste or nutritional combination that is desired.

### BRIEF DESCRIPTION OF DRAWINGS

In the drawings, closely related components have the same number but different alphabetic suffixes.

FIG. 1 Rollable substantially flat sheet.

FIG. 2 Rolled flat sheet (empty) to emphasize its variability.

FIG. 3 Push rod (of desired diameter and length).

FIG. 4 Rolled flat sheet and stuffing contained therein.

FIG. 5 Food to be stuffed, having had an aperture hence cavity cut into it and rolled sheet filled with desired stuffing contained and partially inserted.

FIG. 6 Rolled sheet with stuffing completely inserted into food being stuffed with push rod in position for placement inside rolled sheet.

FIG. 7 Insertion of push rod into exposed end of rolled flat sheet and urging forward the push rod to inject desired stuffing.

FIG. 8. Stuffed item that indicates the stuffing has been deposited to desired depth and quantity, after which the rolled flat sheet and the push rod may be cleaned and re-used for a similar or a different application.

FIG. 9 Kit of parts as presented but not limited to the following components either in number or dimension.

### REFERENCE NUMERALS IN DRAWINGS

10. substantially flat rollable sheet.

11. push rod of desired length and diameter.

11a. about 0.625 inches diameter push rod.

11b. about 0.750 inches diameter push rod.

11c. about 0.875 inches diameter push rod.

12. stuffing selected.

13. food item to be stuffed.

14. rubber bands or other means of securing components of kit for convenient storage

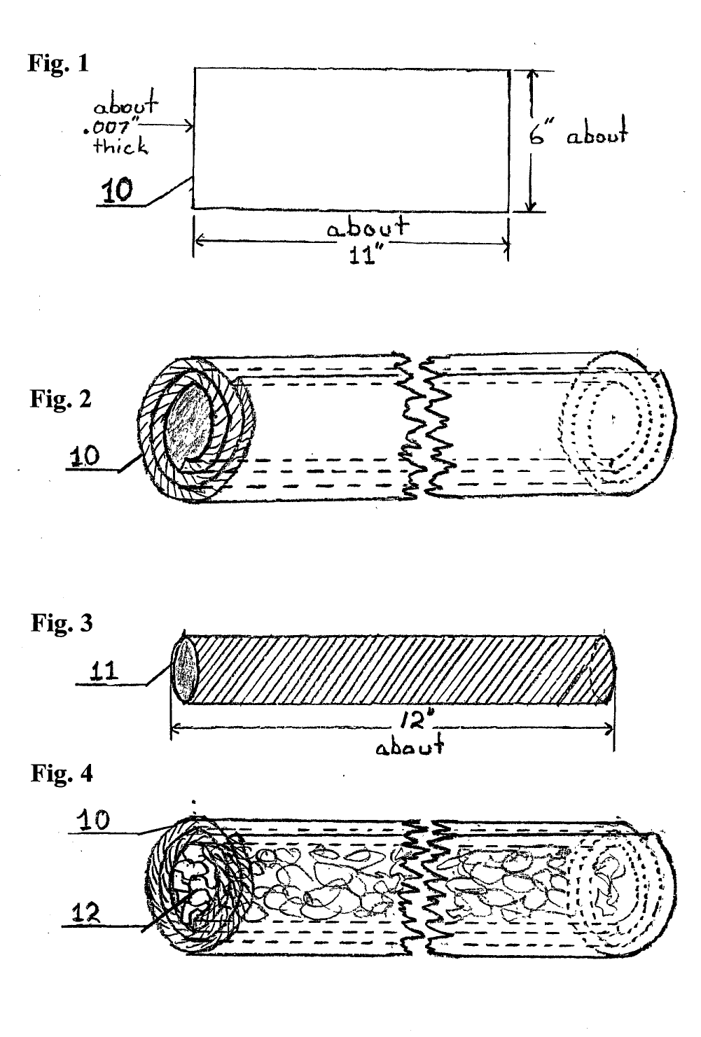

### DESCRIPTION—FIGS. 1 THROUGH 9—PREFERRED EMBODIMENT

A preferred embodiment of the present invention would be a kit of parts consisting of the following components.

a. Two sheets of substantially flat rollable sheet of about the following dimensions.

1. One sheet about 0.007 inches thick by 6 inches wide by 11 inches in length.

2. One sheet about 0.007 inches thick by 8 inches wide by 11 inches in length

b. Three push rods of about the following dimensions

1. One push rod of about 0.625 inches diameter by about 12 inches in length.

2. One push rod of about 0.750 inches diameter by about 12 inches in length.

3. One push rod of about 0.875 inches in diameter by about 12 inches in length.

Used as intended, these components of about the specifications previously mentioned will enable a chef to professionally and expeditiously stuff food items. Until now slicing the food item completely open depositing the stuffing then closing Sewing, tying or using wooden or metal rods to ensure the food item will retain the stuffing placed within.

A preferred embodiment as to the use of the kit of parts and the method for, which at this time is most suited to them, is as follows.

Once the chef has chosen a food item to be stuffed, the chef will then utilize a knife or other instrument of sufficient length that is capable of slicing the selected food item. Starting at (usually) the larger end will pierce the food item and while not cutting through the sides, will urge the knife blade to a depth desired. At this point the knife will be used to cut and enlarge the aperture created by the insertion of the knife blade into the food item to be stuffed.

The chef would then select the flat sheet of choice (FIG. 1) 10 and place it on the work surface in such a way that the longer side of the sheet is toward the chef. At this time the chef would place a quantity of stuffing on the upward facing surface of the flat sheet. While lifting the edge nearest the chef, the edge will be turned to the upward facing surface of the sheet and rolled in a clockwise motion (FIG. 2) 10. Once completely rolled with the desired stuffing inside (FIG. 4) 10, 12, the push rod selected (FIG. 3) 11 will be closest in diameter to the inside diameter of the rolled sheet containing the stuffing.

At this time (FIG. 5) the rolled sheet 10 with the stuffing 12 would be introduced to the food item 13 to be stuffed. This is accomplished by opening the aperture and easing the rolled sheet into the food item while applying a slight clockwise rotational movement. This will assist the insertion of the rolled sheet and also prevent the edges of the rolled sheet from getting caught and causing the rolled sheet to try and become unrolled.

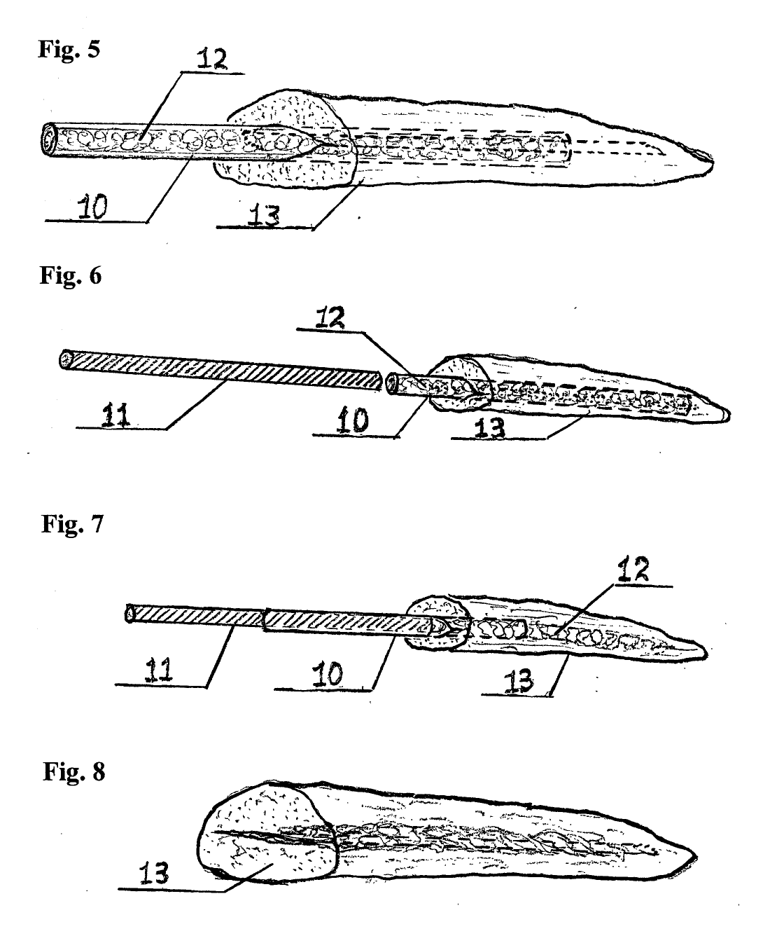

Once the rolled sheet 10 and stuffing 12 have been inserted to the desired depth (FIG. 6) in the food item 13. The push rod of choice 11 may be inserted into the exposed end of the rolled sheet 10 and urged forward while gently grasping the outer surface of the rolled sheet 10.

As the push rod 11 is urged into the rolled sheet 10, the stuffing 12 within (FIG. 7) will be deposited as desired by the chef into the food item 13. Gently restrain the rolled sheet 10, this will assist in the complete deposition of the stuffing 12 into the food item 13. At this time the sheet 10 and push rod 11 may be used again on a similar food item or washed for the next use.

When the food item (FIG. 8) 13 is completed, the stuffing placed within will fill the entire cavity created by the chef in the first step and will stay contained without the need of sewing or using wooden or metal rods to hold the food item closed.

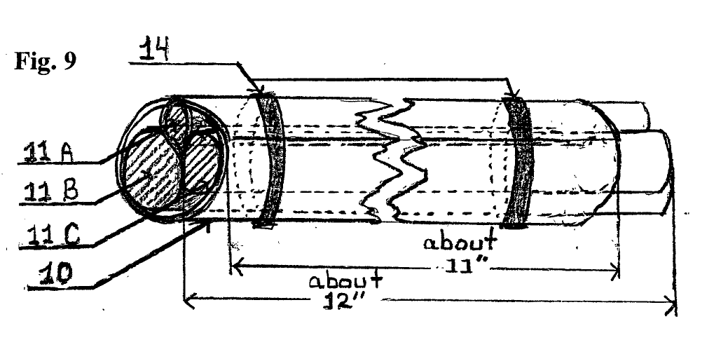

The invention as presented (FIG. 9) should in no way be construed as being the only embodiment that it may assume. Any number of rollable flat sheets and push rods of any dimension and or specification can be visualized. Just as an example, (FIG. 9) demonstrates how the present invention may appear in such a condition as would be used for storage, and the components restrained in a very compact bundle by rubber bands 14 or other means. Rolled sheet 10 could assume many different sizes, but for this example we will use a sheet of about 0.007 inches thick by about 6 inches wide and by about 11 inches in length. The push rods 11A, 11B, 11C, are all about 12 inches in length, but vary in diameter from 11A 0.625 inches, 11B 0.750 inches and 11C 0.875 inches. This selection of diameters will most certainly allow the chef a wide range of flexibility when stuffing various sized food items.

### ADVANTAGES

Accordingly from the description presented above, the advantages of my invention are evident and not limited to the following.

(a) The afore-mentioned stuffing may be viscous such as mustard, or other thick sauces.

(b) Viscous and solid, such as a combination of a thick sauce and capers, olives, chopped onions.

(c) Solids such as whole roasted red peppers, mushrooms, pieces of cheese, sliced or diced vegetables.

(d) The infinitely variable rollable flat sheet permits any desired diameter and it also encourages creativity by enabling the chef to actually place items in a stratified order. This will effect both the tastes of the food being stuffed and also its visual impact. A good example of this would be to create an aperture, thus a cavity into a pork tenderloin to the desired depth and width without cutting through the sides. Slice open roasted red peppers and lay them out flat on the upward facing surface of the rollable flat sheet. On the peppers place some sauteed scallions and roll the edges of the peppers over the scallions and then roll up the flat sheet so as to enclose the pepper and scallion stuffing. While rolling the sheet take notice that some variation in the diameter will occur. Select the push rod that most closely fits the inside diameter of the rolled sheet. While inserting the rolled flat sheet and stuffing exert a slight rotational force (so as to not unwrap the cylinder) to assist the insertion. After placing the rolled sheet with stuffing therein into the food being stuffed to the desired depth. Insert the selected push rod and urge the push rod forward while gently grasping the rollable flat sheet. This will allow the stuffing to be deposited as desired and the rolled flat sheet will slide out as the stuffing is urged into the food being stuffed. Once cooked and sliced across the length, a pattern containing in it's center, scallions surrounded by roasted red peppers and then enveloped with pork tenderloin. The same can be accomplished with fish fillets, fowl breast, or any stuffable food item in which a aperture and cavity can be created to accommodate the desired quantity of stuffing

(e) Said devices capability is limited only by the imagination of the chef.

(f) It is not mechanical, is infinitely variable as to its capacity, is of few components, is very easy to keep clean and sanitary, and is easily utilized by anyone capable of preparing food.

(g) The invention being proposed has been tested hundreds of times where in the same sheets and rods have been cleaned and reused constantly to stuff all manner of foods imaginable. The invention has worked flawlessly on all occasions.

(h) This invention consists of a desired number of rollable sheeting, and push rods of desired lengths and diameters.

### OPERATION

The manner of using the present invention is very efficient, and will yield exceptional results every time, even for the novice chef. The following steps embrace the essence of the use and operation of my invention

(1) Preparing a stuffable food item by creating an aperture and a cavity there in.

(2) Selecting the rollable flat sheet.

(3) Placing the edible stuffing onto the upward-facing surface of said flat sheet in the desired amount.

(4) Rolling said flat sheet so as to encase said stuffing of choice inside.

(5) Select the push rod most closely fitting the inside diameter of said rolled flat sheet with stuffing therein.

(6) Insert one end of the rolled flat sheet into said aperture created and asaid cavity created within said stuffable food item.

(7) With a gentle rotational motion in the same direction as said flat sheet was rolled, insert said rolled sheet and stuffing to the desired depth within said cavity.

(8) Introduce said selected push rod to the exposed end of said rolled sheet and stuffing.

(9) Urge said push rod thereby beginning placement of said edible stuffing within said stuffable food item.

(10) Maintain a gentle grasp of said rolled flat sheet, thus allowing said food item being stuffed to slide off of said rolled sheet while said push rod is being urged forward. There may also be occasion to restrain slightly said food being stuffed, so a larger quantity of stuffing may be deposited as desired.

(11) Deposit the desired quantity of stuffing.

(12) Said process may be repeated following unrolling of said flat sheet and cleaning of said sheet and or push rod if required.

### CONCLUSION, RAMIFICATION, AND SCOPE

Consequently the reader will note that the manner of using this present invention, is very different from all other prior art thus found. The method of operation is consistent regardless of the object being stuffed; the push rod may change, as the chef desires. This may be due to any number of factors which would increase or decrease the quantity of stuffing, which in turn has a direct bearing on the size of the rollable flat sheet once filled with the stuffing desired. This method of stuffing food items is very easy to learn by anyone who is capable of preparing food. This device is extremely durable, and when made of the appropriate materials such as Lexan or Acrylic it is also considered FDA and USDA approved for use with all food products. Utilizing transparent materials also allows the chef to view the stuffing prior to being placed into the food item to be stuffed. Much larger objects could also be stuffed by changing the size of the rollable flat sheet and the size of the push rod being used.

Although the description of my invention as discussed previously contains certain specifications, these should not be construed as limiting the scope of the invention but as merely providing illustrations of some of the presently preferred embodiments of this invention.

What is claimed is:

1. A device which in particular is a kit of parts designed specifically to introduce a edible stuffing into a food capable of being stuffed, said device comprised of.
a. a number of rollable and unrollable substantially flat sheets in desired lengths, widths and thickness.
b. a number of push rods that are of the desired lengths and diameters

2. A method to introduce a desired stuffing into a selected food item without slicing open completely said selected food item, said method comprising the steps of.
a. providing a food item in which stuffing is to be placed.
b. cutting an aperture from one point of said food item and therefore creating a cavity of desired width and depth to accommodate said stuffing.
c. selecting a rollable and unrollable substantially flat sheet of the desired length width and thickness.
d. depositing desired quantity of said stuffing onto the up-ward facing surface of said flat sheet.
e. rolling said flat sheet into a cylinder therefore encasing the stuffing therein.
f. introducing said cylinder into said aperture, applying a gentle rotational movement while urging forward said cylinder with said stuffing therein into said cavity to desired depth.
g. selecting a push rod of desired diameter and length.
h. manually urging said push rod against said stuffing contained within said rolled flat sheet, thereby depositing said stuffing into said cavity to said depth and said quantity, while withdrawing said flat sheet from within said item being stuffed.
Whereby said stuffable food item will be filled to said desired capacity with said stuffing with no requirement for sewing, tying or skewering of said food item to retain said stuffing there within.
